(19) United States
(12) Patent Application Publication
(10) Pub. No.: US 2009/0256707 A1
(43) Pub. Date: Oct. 15, 2009

(54) DEVICE AND METHOD TO PREVENT DAMAGE TO OBJECTS MOUNTED ON TOP OF AUTOMOBILES

(76) Inventors: Robert C. Uschold, Leominster, MA (US); James E. Uschold, New Orleans, LA (US); Robert J. Strowe, Ramsey, NJ (US)

Correspondence Address: Kristina M. Grasso;Kristina M. Grasso, Esq. PLLC, P.O. Box 162, Milford, NH, 03055, US

(21) Appl. No.: 12/405,167

(22) Filed: Mar. 16, 2009

Related U.S. Application Data
(60) Provisional application No. 61/069,726, filed on Mar. 15, 2008.

(51) Int. Cl. G08B 13/14; G01S 1/00

(52) U.S. Cl. 340/568.1; 342/357.09

(57) ABSTRACT

The invention, a device and method to prevent an automobile with an object on the roof rack from entering a garage, has three main components. The first component is the detector. It is mounted on a roof style bike rack. When a bicycle is mounted on the rack, it activates a switch on the detector, causing the detector to emit a radio signal. The second unit is the proximity transmitter. It is mounted on or near the garage door. The proximity transmitter emits a continuous signal. The third unit is the base unit. It is mounted inside the automobile. When the base unit detects a signal from both the detector and the proximity transmitter, it emits an audible and/or visual alarm that warns the driver he is approaching his home garage and there is a bicycle on top of the car.

### RELATED US APPLICATION DATA

This application claims the benefit of U.S. Provisional Patent Application No. 61/069,726 filed Mar. 15, 2008, which is incorporated by reference herein in its entirety.

### BACKGROUND OF THE INVENTION

This invention relates to protecting objects carried on the roof of an automobile. One object commonly carried in this way is a bicycle. One or more bicycles can be attached to the automobile via a roof mounted racks. A risk associated with this practice is forgetting that the bicycle is on the automobile when returning home. It is well known for people to attempt to enter their garage with the bicycle still on the roof. When this happens, damage can occur to the bicycle, the roof rack, the automobile, and the garage. Cases are also known where drivers have difficulty getting insurance reimbursement for the accident. Automobile insurers may say the damage should be covered by homeowners insurance. Homeowner insurers may say the damage should be covered by the automobile insurance.

There are some existing solutions to this problem. One is to place a garbage can or other object in the entrance of the garage so that when returning, the car cannot enter the garage. The object serves as a reminder to the driver. Another method is to place a mirror above the garage door so that when attempting to enter the garage, the bicycle can be seen, reminding the driver to remove it. Another method is to put the car's garage door opener in an inconvenient place. When retrieving the opener, the driver is more likely to remember the bicycle is on the automobile. Another option some use is to discontinue parking the car in the garage. Finally, there are numerous collision avoidance systems for automobiles based on video signals or interpreting the reflections from laser or ultrasonic sources. These are used to find and identify hazards in the vehicle's path.

There are shortcomings to all of these solutions. The garbage can method requires the driver to place and remove the garbage can or other object. That is two extra steps added to the process of going for a bike ride. Additionally, it is possible for the driver to forget to place the object or for someone other than the driver to move the object. The mirror method requires a large mirror so that it is not overlooked when entering the garage. A large mirror mounted above the garage is not aesthetically pleasing. Putting the garage door opener in a hard to access place is an inconvenience and a step that can be forgotten. The option of not using the garage has the obvious shortcoming that the driver no longer enjoys the benefits of parking their car in a garage. The collision avoidance systems have the shortcoming that they do not have the ability to detect when there is a difference in the vehicle, such as the presence or absence of a bike on top. Without this capability, the collision avoidance system will give many false positives. This could result in the user ignoring a genuine positive and cause a collision.

### SUMMARY OF THE INVENTION

The invention, a device and method to prevent an automobile with an object on the roof rack from entering a garage, comprises three main components. The first component is the detector. It is mounted on a roof style bike rack. When a bicycle is mounted on the rack, it activates a switch on the detector, causing the detector to emit a radio signal. The second unit is the proximity transmitter. It is mounted on or near the garage door. The proximity transmitter emits a continuous signal. The third unit is the base unit. It is mounted inside the automobile. When the base unit detects a signal from both the detector and the proximity transmitter, it emits an audible and/or visual alarm that warns the driver he is approaching his home garage and there is a bicycle on top of the car.

The advantages of the invention over the prior art is that after the device is installed, the driver is automatically warned when he is at risk of driving into his garage with a bicycle on the roof. He is not required to remember a step, as in the garbage can method and hiding the garage door opener method. Further, a second party cannot interfere with the reminder as the garbage can method permits. He does not need to look in a certain area to see if a bicycle is present, as with the mirror method. The driver is not inconvenienced by having to place and retrieve the garage door opener in an inconvenient place. With this invention, the driver retains the benefits of parking their car in a garage. Finally, this invention does not generate as many false positives as the collision avoidance systems.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The above and other advantages of the present invention will be apparent upon consideration of the following detailed description, taken in conjunction with accompanying drawings, in which like reference characters refer to like parts throughout, and in which:

FIG. 1a is a perspective view of the top side of the detector.

FIG. 1b is a perspective view of the bottom side of the detector.

FIG. 2 is a perspective view of the inside of the detector.

FIG. 3 is a perspective view of the detector attached to a bicycle tray mounted to an automobile roof rack.

FIG. 4 is a perspective view of the detector attached to a bicycle tray mounted to an automobile roof rack and activated by a bicycle.

FIG. 5 is a perspective view of the proximity detector.

FIG. 6 is a perspective view of the inside of the proximity detector.

FIG. 7 is a perspective view of the base unit.

FIG. 8 is a perspective view of the inside of the base unit.

FIG. 9 is a perspective view of the fork clamping mechanism of a bicycle tray.

FIG. 10 is a perspective view of bicycle tray with a hollow cross section.

FIG. 11 is a perspective view of a storage box mounted on top of a vehicle.

FIG. 12 is a perspective view of a scanner unit

FIG. 13 is a perspective view of the inside of the scanner unit.

FIG. 14 is a perspective view of a scanner unit attached to a motor vehicle.

### DETAILED DESCRIPTION OF THE INVENTION

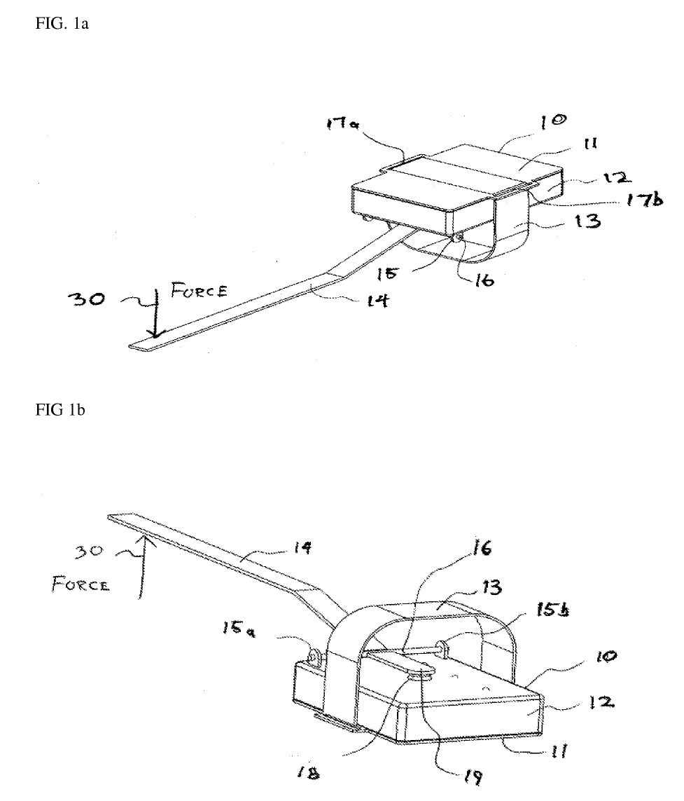

FIG. 1 is a perspective view of the top side of the detector 10, comprising a top cover 11 and a bottom cover 12. The switch arm 14 is pivotably attached to the bottom cover 12 at the axle 16 and the bearing 15. Strap 13 goes around the detector 10 through the slot 17a and 17b on the top cover 11. Strap 13 is used to secure the detector to the tray of a roof mounted bicycle rack.

FIG. 1b is a perspective view of the bottom side of the detector 10. Switch button 18 protrudes through the bottom cover 12. The activator tip 19 is part of the switch arm 14 and contacts the switch button 18. In this view, a bicycle wheel would apply a force 30 to move the switch arm up. The switch arm pivots at the axle 16 and bearing 15 so that the activator tip 19 pushes down on the switch button 18.

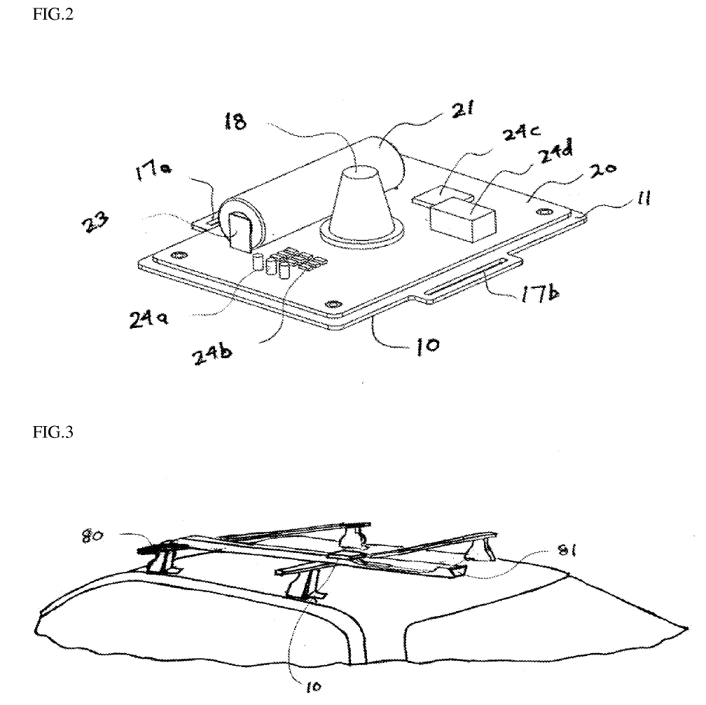

FIG. 2 is a perspective view of the inside of the detector 10. PC board 20 is attached to the top cover 11. The switch button 18 is seen near the center of the PC board 20. The PC board 20 is populated by numerous components 24a, 24b, 24c, and 24d. These components may be resistors, capacitors, processor chips, and other electronic components. At least one of the components must be a radio transmitter. Battery 21 contacts terminal 23 and provides power to the PC board 20.

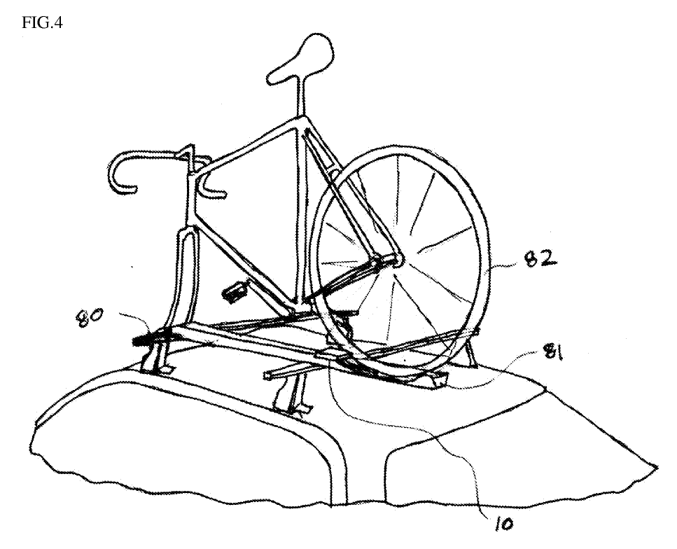

FIG. 3 is a perspective view of the detector 10 attached to a bicycle tray 81 mounted to an automobile roof rack 80.

FIG. 4 is a perspective view of the detector 10 attached to a bicycle tray 81 mounted to an automobile roof rack 80 and activated by a bicycle wheel 82.

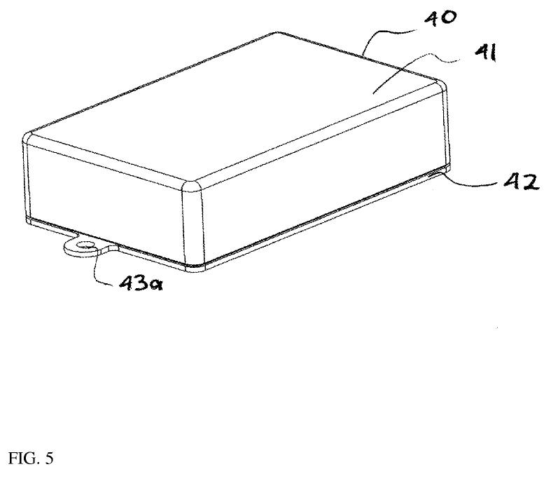

FIG. 5 is a perspective view of the proximity detector 40 comprising a top cover 41 and a bottom cover 42. Mounting hole 43a is used to attach the proximity detector 40 to a garage or garage door.

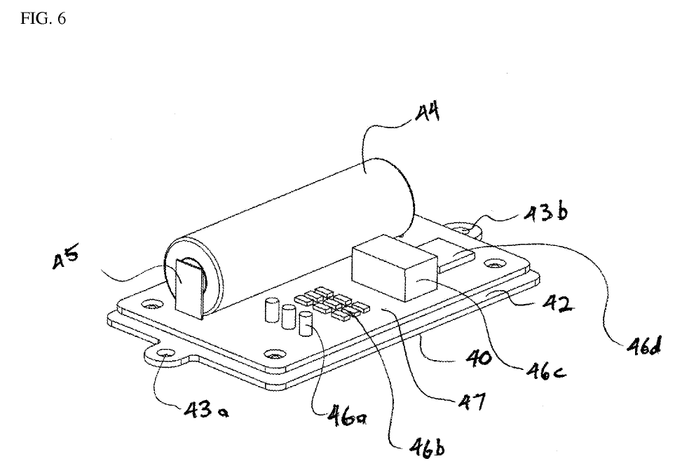

FIG. 6 is a perspective view of the inside of the proximity detector 40. PC board 47 is attached to the bottom cover 42. The PC board 47 is populated by numerous components 46a, 46b, 46c, and 46d. These components may be resistors, capacitors, processor chips, and other electronic components. At least one of the components must be a radio transmitter or receiver. Battery 44 contacts terminal 45 and provides power to the PC board 47.

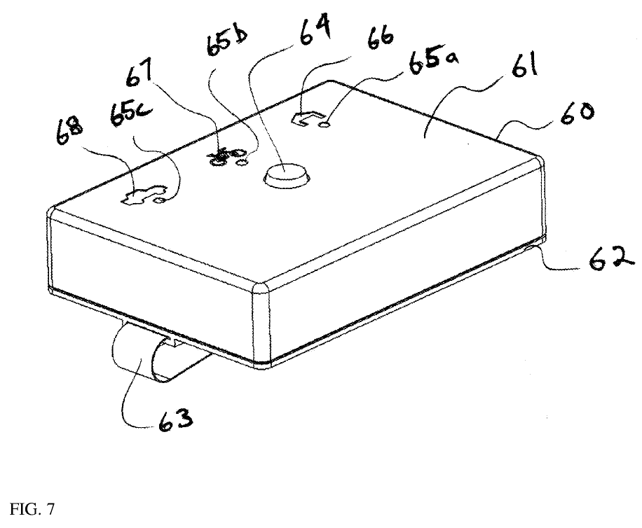

FIG. 7 is a perspective view of the base unit 60 comprising a top cover 61 and a bottom cover 62. Clip 63 is attached to the bottom cover 62. The clip is used to attach the base unit 60 to an automobile sun visor. Reset button 64 protrudes out of the center area of the top cover 61. LEDs 65a, 65b, and 65c protrude out of the top cover. Markings 66, 67, and 68 label the top cover to identify the LEDs 65a, 65b, and 65c.

FIG. 8 is a perspective view of the inside of the base unit 60. PC board 75 is attached to the bottom cover 62. The switch button 64 is seen near the center of the PC board 75. The PC board 75 is populated by numerous components 72a, 72b, 72c, and 72d. These components may be resistors, capacitors, processor chips, and other electronic components. At least one of the components must be a radio receiver or transmitter. Battery 69 contacts terminal 70 and provides power to the PC board 75.

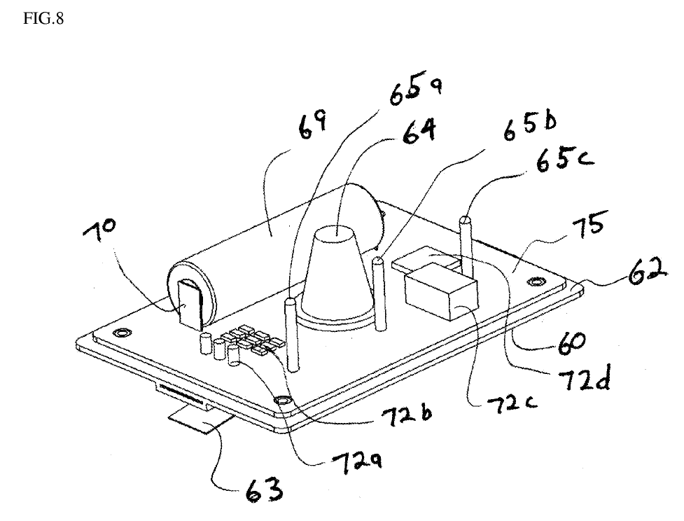

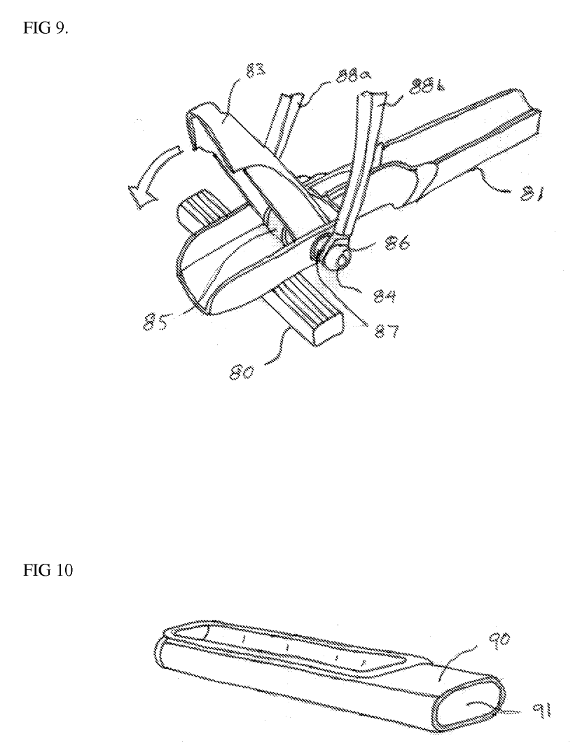

FIG. 9 is a view of the fork clamping mechanism of a bicycle tray 81 that is clamped to a roof rack 80. The fork clamping mechanism consists of a cover 83, a spindle 84, and a cam mechanism 85. The cover 83 is shown in an open position. The spindle contains a fixed element 87 and a movable element 86. When the cover is in an open position, there is a gap between the fixed element 87 and the movable element 86. The gap allows the fork arms 88a and 88b to be inserted into the gap. When the cover 83 is closed, the cam mechanism 85 causes the gap to be reduced in size and thus the spindle 84 securely retains the fork arms 88a and 88b.

FIG. 10 is a perspective view of bicycle tray 90 with a hollow cross section. The hollow space 91 could contain a variation of the detector 10 shown in FIG. 1a.

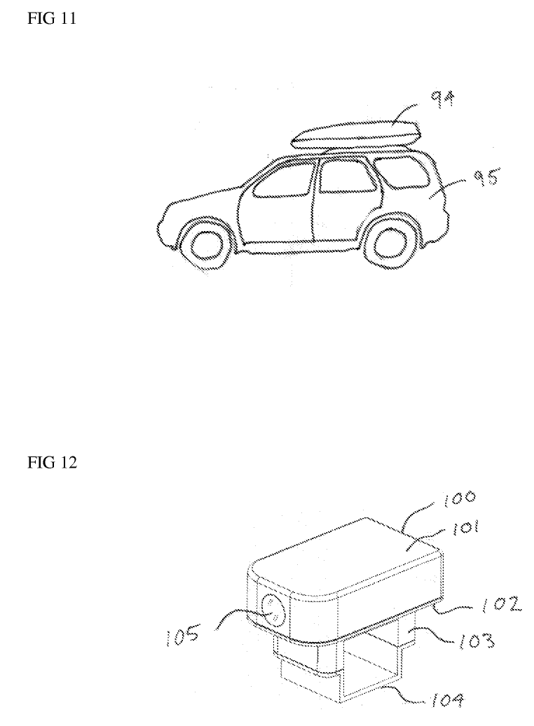

FIG. 11 is a side view of a storage box 94 mounted on top of a vehicle 95.

FIG. 12 is a perspective view of a scanner unit 100 comprising a top cover 101, a bottom cover 102, a window 105, and a clamp 104. The clamp 104 attaches to the mating clamp features 103 on the bottom cover 102. The clamp 104 and clamp features securely retain the scanner unit 100 to a cross bar of an automobile roof rack. The window 105 allows transmission of a signal, which could be ultrasonic, infrared, or laser.

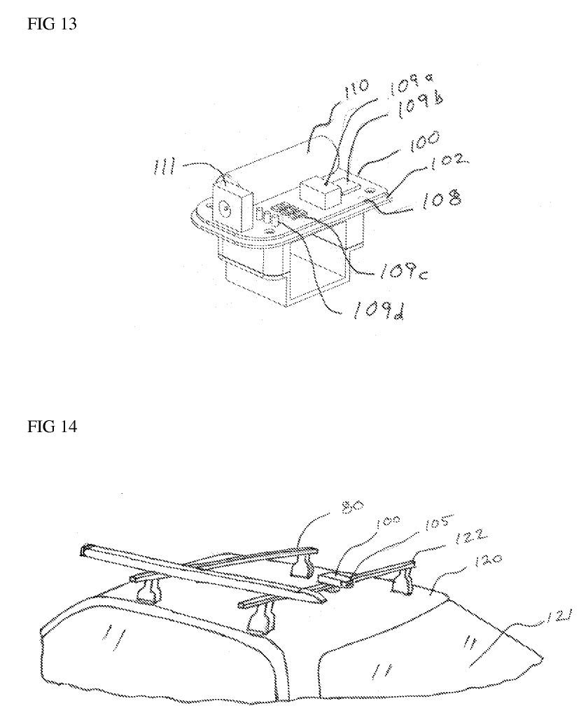

FIG. 13 is a perspective view of the inside of scanner unit 100. PC board 108 is attached to the bottom cover 102. The PC board 108 is populated by numerous components 109a, 109b, 109c, and 109d. These components may be resistors, capacitors, processor chips, and other electronic components. At least one of the components must be a radio transmitter or receiver. Also attached to the PC board is the scanner assembly 111. The scanner assembly 111 contains a transmitter that emits a signal; such as ultrasonic, infrared, or laser; and a receiver to detect reflections of the emitted signal. Battery 110 provides power to the PC board 108.

FIG. 14 is a perspective view of a scanner unit 100 attached to the cross bar 122 of the roof rack 80 of a motor vehicle 120.

This embodiment of the invention comprises three components. As shown in FIG. 1, the first component is the detector. It may be mounted on a roof style bike rack as shown in FIG. 3. As shown in FIG. 5, the second unit is the proximity transmitter. It may be mounted on or near a garage door. As shown in FIG. 7, the third unit is the base unit. It may be mounted inside the automobile.

The first unit, the detector, is attached to the tray of the roof rack that holds a bicycle as shown in FIG. 3. The detector has a switch that is activated when a bicycle is properly mounted on to the tray. When the switch is activated, the detector sends out a continuous radio signal to be detected by the base unit. The signal may be constant or intermittent. An intermittent signal would provide for reduced power consumption. In this embodiment, shown in FIG. 4, the wheel of the bicycle activates the switch. The unit is battery powered. When the battery power is low, it sends a radio signal to the base unit. An important feature of this unit is high resistance to water ingress. In normal use, it can be expected to encounter rain while the car is driving 65 miles per hour or more.

The second unit, the proximity transmitter, is mounted on or near the user's garage door. This unit is continuously emitting a radio signal. The signal may be constant or intermittent. An intermittent signal would provide for reduced power consumption. The signal is to be detected by the base unit. The unit is battery powered. When the battery power is low, it sends a radio signal to the base unit. Resistance to weather is necessary for this unit.

The third unit, the base unit, is placed inside the automobile. In this embodiment, it is attached to the sun visor. The unit has a receiver that receives the radio signals transmitted from the detector and the proximity transmitter. When the base unit is receiving a signal from both the detector and the proximity transmitter, it gives an alarm to remind the driver of the car that there is a bicycle on top and they are approaching their home garage. The alarm may be visual and/or audible. If a bicycle is not on top, the base unit will not emit an alarm when the home garage is approached. When a bicycle is on top, the base unit will not emit an alarm if it is not near to the home garage. In this embodiment, the base unit also has a button that the user can press to temporarily override and mute the alarm. The base unit also has three LEDs. By each LED on the cover of the base unit are markings representing the three units of the invention: detector, proximity detector, and base unit. When one of the three units has a low battery condition, the LED closest to the appropriate marking turns on to inform the user of this condition. The unit is battery powered. This unit requires the ability to operate in the high temperatures that may be in the interior of an automobile.

In another embodiment of the invention, the detector is integrated into the clamping portion of the tray of the roof rack. As shown in FIG. 9, some trays secure the bicycle by clamping onto the fork of the bicycle with the front wheel removed. In this embodiment, the detector above is integrated such that the normal action to clamp and secure the bicycle to the rack activates the switch on the detector. The electronics and battery of the detector are incorporated into the clamping mechanism of the tray. A switch is installed in the area that clamps and secures the bicycle fork. The switch is designed so that when the clamp is open or closed with no bicycle attached, the switch is open. When the clamp is closed onto and securing a bicycle fork, the switch is closed. When the switch is closed, the detector sends out a radio signal to be detected by the base unit. Those skilled in the art could develop other means of integrating a switch into a clamping mechanism, including clamping mechanisms that clamp the wheel or frame of the bicycle.

In another embodiment of the invention, the detector is integrated into the body of the tray of the roof rack. As shown in FIG. 10, there are trays that have a substantially hollow cross section. In this embodiment, the detector above is integrated such that the weight of the bicycle activates the switch on the detector. The electronics and battery of the detector are incorporated into the hollow cross section of the tray. The switch is designed so that when no bicycle is attached, it is open. When a bicycle is attached, the weight of the bicycle closes the switch. When the switch is closed, the detector sends out a radio signal to be detected by the base unit. An advantage of this embodiment is that the electronics of the detector are less exposed to rain than in the other embodiments. Those skilled in the art could develop other means of integrating a switch into a tray that is not hollow.

In another embodiment of the invention, the detector is attached to a carrier box that is attached to the roof rack. See FIG. 11. The detector switch is designed to be turned on when the box is attached to the roof rack. In this embodiment, the invention protects the user from driving their automobile into the garage with a storage box on top. Additional embodiments of the invention that are capable of protecting other objects mounted to the roof rack can be developed by those skilled in the art. Examples of additional objects are boats, snowboards, and ladders.

In another embodiment of the invention, the proximity unit is powered by standard household AC current. The user would plug it into an outlet in or near their garage. In this embodiment, the base unit would have only two low battery LEDs.

In another embodiment of the invention, the base unit also contains a global positioning system (GPS) receiver. The driver would program the home location into the global positioning system enabled base unit. The base unit would give an alarm when a bicycle is on top and the car is near to the home location. In this embodiment, the proximity unit is not required. The driver is also able to program locations in addition to his home location into the base unit. This feature allows the invention to protect the driver in multiple locations. Additionally, locations could be downloaded from databases generated by local, state, or federal agencies and/or private entrepreneurs. These databases could be sortable according to their actual clearance so that the user only needs to download locations that are actual problems. Another feature that may be incorporated into this embodiment is an override of the GPS receiver power off means. When the detector unit indicates the presence of a bike, the base unit disables the ability to turn off the GPS. This is necessary because people may turn off their GPS when they are returning home because they do not require it. If the GPS were turned off, the user would not be warned when approaching their home garage or any other obstacle that they may encounter.

Another version of the embodiment above eliminates the detector unit. This can be done when the vehicle always has a tall height, such as a truck. In this embodiment, the base unit sounds an alarm whenever the GPS receiver detects that the vehicle is near to a program location.

In another embodiment of the invention, the base unit is also a garage door opener. When the base unit detects signals from both the detector and the proximity unit, it prevents the garage door opener from sending a signal to open the garage door. At all other times, the base unit works like a standard garage door opener. The alarm features of the base unit are retained in this embodiment in order to provide a warning when an automobile with an object on the roof approaches the garage and the door is already open.

In another embodiment of the invention, the proximity transmitter can be mounted in multiple public locations, such as parking garages or overhangs at restaurant drive through lanes, that have clearance heights lower than traffic that might pass under. In this embodiment, the user is protected in many locations, wherever a proximity unit is mounted, not just at their home garage. In this embodiment, the location where the proximity transmitter is mounted must take into consideration the sensitivity of the base unit, the signal strength of the proximity transmitter, and the actual speeds at which higher clearance vehicles may approach low clearance objects. One skilled in the arts of signal strength, range, and detection; reaction times; and stopping distances for different vehicles can calculate the optimal and/or minimum distances from low clearance objects at which a warning to the operator of the higher clearance moveable object must be received in order to allow the operator to safely avoid a collision. For example, it may be necessary for a proximity transmitter to be located a quarter mile or more from the low clearance object to which it relates. Such a location is “in the functional vicinity of” the low clearance object.

In another embodiment of the invention, the proximity unit is replaced by a scanner unit that is mounted near the garage door and there is no detector unit. The scanner unit has an emitter that sends out an ultrasonic, infrared, or laser pulse. The pulse is emitted away from the garage and down the driveway in the direction from which a vehicle would approach. The scanner unit also contains a sensor that reads the reflected ultrasonic, infrared, or laser pulse. Using appropriate algorithms, the scanner evaluates the details of the reflected pulse and determines when a vehicle is approaching and whether there is an object on top, such as a bicycle or boat. The scanner unit also has a radio transmitter in it. If there is an object on top of the vehicle, the scanner unit sends a signal to the base unit. When the base unit receives a signal from the scanner, it gives an audible and/or visual alarm.

Another version of the embodiment above eliminates the base unit. The scanner unit has a light and/or speaker instead of a radio transmitter. When the scanner unit detects a hazard, the light flashes or the speaker sounds to warn the driver.

In another embodiment of the invention, the proximity unit is replaced by a scanner unit that is mounted on the car facing in a forward direction. See FIGS. 12, 13, and 14. The scanner unit has an emitter that sends out an ultrasonic, infrared, or laser pulse. The pulse is emitted forward in the direction in which a vehicle would travel. The scanner unit also contains a sensor that reads the reflected ultrasonic, infrared, or laser pulse. Using appropriate algorithms, the scanner evaluates the details of the reflected pulse and determines when the vehicle is approaching a hazard. The hazard may be a residential garage, a public parking garage, a low bridge, a restaurant drive through overhang, a low branch, or any other low object that a vehicle may travel under. The scanner unit also has a radio transmitter that sends a signal to the base unit when it detects a hazard. In this embodiment, the user is protected in any location where there is a hazard, not only locations where there is a proximity unit mounted.

Another version of the embodiment above places the scanner unit inside of the car instead of on the car. The scanner unit would also contain a radio receiver that would receive a signal from the detector unit and a light and/or speaker with which to provide an alarm to the user. The scanner unit would issue an alarm when it receives a signal from the detector unit and it detects a hazard. This embodiment eliminates the need for the base unit.

In another embodiment, the detector unit has an emitter that sends out an ultrasonic, infrared, or laser pulse. The detector unit is mounted on the roof of the car in a center forward position. The pulse is emitted rearward towards where bicycles, storage boxes, boats, or other objects would be mounted on the roof of the vehicle. The scanner unit also contains a sensor that reads the reflected ultrasonic, infrared, or laser pulse. Using appropriate algorithms, the scanner evaluates the details of the reflected pulse. The scanner also has a memory that can record the details of the reflected pulse when there is nothing mounted on the roof of the vehicle. This memory is the baseline to which future reflected pulses are compared. When an object is mounted on the roof of the vehicle, there would be a change in the details of the reflected pulse. The scanner compares the new details with the saved details and determines that an object is mounted on the roof of the vehicle. When an object is mounted to the roof, the scanner unit sends out a radio signal to be detected by the base unit. The memory of the scanner unit can be updated at the user's discretion. This would be done when a new bicycle tray is added or a short object, such as a pair of skis, is mounted on the roof. These additions would cause the details of the reflected pulse to be different from the saved details but would not indicate a condition where a low object would be a hazard. The user would update the saved memory to prevent false positive alarms.

Another version of the embodiment above replaces the pulse and sensor with a passive infrared detector (PID). The PID faces rearward towards where bicycles, storage boxes, boats, or other objects would be mounted on the roof of the vehicle. A base condition is established with nothing mounted on the roof rack. When a bicycle or other object is mounted on to the roof rack, the PID detects the change from the base condition and transmits a signal to the base unit. This embodiment also has the ability to reset the base condition when a new bicycle tray is added or a short object, such as a pair of skis, is mounted on the roof.

In another embodiment, there is only a proximity transmitter and a base unit. In this embodiment, the base unit generates an alarm when it detects the proximity transmitter. One application of this embodiment would be for trucking companies with trucks of multiple sizes and garages that that cannot accommodate the larger trucks. A base unit would be placed in the larger trucks and a proximity transmitter would be placed by a garage opening that cannot accommodate that truck. Using this invention, the driver of the truck would be warned whenever approaching the garage with low clearance.

In another embodiment, radio frequency identification (RFID) tags are used to provide warning. For example, the proximity unit contains an RFID antenna. When the base unit is near to the proximity unit, the antenna would activate an RFID chip in the base unit, indicating the proximity of the user's home garage. If the detector indicates a bike is attached to the car, the base unit would then sound the alarm. Additionally, RFID antennas could be mounted in public locations to provide additional areas of protection.

Another version of the embodiment above would have height information of the vehicle embedded in the RFID chip of the base unit and height information of the hazard that the proximity unit is attached to embedded in the proximity unit. There is also a signal output on the proximity unit, such as a light or horn. When the vehicle approaches the proximity detector, the antenna would activate the RFID chip, causing it to transmit a signal containing the height information back to the proximity unit. If the height of the vehicle is greater than the height of the hazard, the proximity unit would activate the signal output, warning the driver of the vehicle.

It is recognized that those skilled in the art could develop new permutations of the disclosed embodiments that provide the desired effect of preventing a vehicle that has a high clearance height from driving under hazards that have a low clearance height. For example, one might develop variations with different combinations of receivers and transmitters in the three units of the first embodiment. Additionally, vehicles may or may not have a trailer attached. A boat moving in the water could be considered a vehicle with a high clearance height. The high clearance height condition of the vehicle may or may not be permanent. The hazards with a low clearance height may or may not be permanently fixed in location. The low clearance condition of the hazard may or may not be permanent.

While the invention is described in terms of low clearance problems, the invention is adaptable to virtually any insufficient clearance problem, whether vertical, horizontal or of the “square peg in a round hole” variety. For example, a “wide load” approaching a narrow underpass or tunnel may have a horizontal clearance problem. Similarly, outrigger or a crane or boom may need to pass over rather than under an object.

The invention is also adaptable to remotely operated vehicles. In such a system, the warning would be sent to the remote operator rather than to the insufficient clearance vehicle. The means of identifying and/or detecting an insufficient clearance vehicle, the means of identifying and/or detecting an insufficient clearance hazard, and the means of detecting proximity of the insufficient clearance vehicle to the insufficient clearance hazard need not be located in any specific location or component as long as an output permits a warning signal to be sent to the operator or controller of the vehicle. The signal could also be sent to a controller of the vehicle which would automatically take corrective action. The controller could be completely independent or supplemental to a human operator.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A protection system comprising:
an assembly having a first transmitter, a switch, and a first power source, the assembly being mountable on a vehicle, wherein when the switch is activated, the first transmitter transmits a first signal;
a first box having a second transmitter and a second power source mounted on or near a rigid object; and
a second box having a receiver, an output means, and a third power source, the second box being mountable in or on the vehicle, wherein when the receiver receives the first signal from the assembly and a second signal from the first box, an output is created.

2. The protection system of claim 1 wherein the assembly is in a third box removably attached to a roof rack and wherein the switch of the assembly is activated by the placement of an object in the roof rack.

3. The protection system of claim 1 wherein assembly is removably attached to the roof rack, the roof rack has a clamp to secure the object, and the switch is activated when the clamp is closed and securing the object.

4. A protection system comprising:
an assembly having a first transmitter, a sensor, and a first power source, the assembly being mountable on a vehicle, wherein the sensor detects the presence of an additional object mounted to the outside of the vehicle, so that when the additional object is detected, the first transmitter transmits a first signal;
a first box having a third transmitter and a second power source, the first box being mountable on or near a rigid object that has a low clearance height for motor vehicle traffic; and
a second box having a receiver, an output means, and a third power source, the second box being mountable on or in the vehicle, wherein when the receiver receives the first signal from the assembly and a second signal from the first box, an output is created.

5. The protection system of claim 4 wherein the assembly is housed in a third box, the third box being removably attached to a roof rack.

6. The protection system of claim 4 wherein the sensor is a passive infrared detector.

7. The protection system of claim 4 wherein the assembly also contains a third transmitter and a microprocessor, wherein the sensor detects reflections of pulses emitted by the third transmitter and the microprocessor evaluates the reflections to determine the presence of the additional object mounted to the outside of the vehicle.

8. A protection system comprising:
an assembly having a first transmitter, a switch, and a first power source, the assembly being mountable on a vehicle, wherein when the switch is activated, the first transmitter transmits a signal; and
a first box having a receiver, a second transmitter, a sensor, a microprocessor, a second power source, and an output means, the first box being mounted in or on the vehicle, wherein the sensor detects reflections of pulses emitted by the second transmitter, wherein the microprocessor evaluates the reflections to determine the presence of a rigid object in the field of view that has a low clearance height for motor vehicle traffic, and wherein when the receiver receives a signal from the assembly and the microprocessor detects the presence of the rigid object, an output is created.

9. The protection system of claim 8 wherein the assembly is housed in a third box, the third box being removably attached to a roof rack, and wherein the switch of the assembly is activated by the placement of an object in the roof rack.

10. The protection system of claim 8 wherein assembly is removably attached to the roof rack, the roof rack has a clamp to secure the object, and the switch is activated when the clamp is closed and securing the object.

11. A protection system comprising:
an assembly having a transmitter, a switch, and a first power source, the assembly being mountable on a vehicle wherein when the switch is activated, the transmitter transmits a signal; and
a first box having a receiver, a global positioning system receiver, an output means, a second power source, and a memory means, the first box being mountable in or on the vehicle, wherein the memory means contains coordinates for one or more geographic locations, and wherein when the receiver receives a signal from the assembly and the global positioning system receiver detects that it is at a location near to one of the stored coordinates, an output is created.

12. The protection system of claim 11 wherein the assembly is housed in a third box, the third box being removably attached to a roof rack, and wherein the switch of the assembly is activated by the placement of an object in the roof rack.

13. The protection system of claim 11 wherein assembly is removably attached to the roof rack, the roof rack has a clamp to secure the object, and the switch is activated when the clamp is closed and securing the object.

14. A protection system comprising:
a first box having a first transmitter, a second transmitter, a first sensor, a second sensor, a microprocessor, and a first power source, the first box being mountable on a vehicle, wherein the first sensor detects the presence of one or more additional objects mounted on the vehicle, and wherein the second sensor detects reflections of pulses emitted by the second transmitter and the microprocessor evaluates the reflections from the second transmitter to determine the presence of a rigid object in the field of view that has a low clearance height for motor vehicle traffic, and wherein when the microprocessor detects the one or more additional objects mounted on the vehicle and the rigid object, the first transmitter transmits a signal; and
a second box having a receiver, an output means, and a second power source, the second box being mountable in or on the vehicle, wherein when the receiver receives the signal from the first box, an output is created.

15. The protection system of claim 14 wherein the first box is removably attached to a roof rack.

16. The protection system of claim 14 wherein the first sensor is a passive infrared detector.

17. The protection system of claim 14 wherein the first box also contains a third transmitter, wherein the first sensor detects reflections of pulses emitted by the third transmitter and the microprocessor evaluates the reflections to determine the presence of the one or more additional objects mounted to the outside of the vehicle.

18. A protection system comprising:
an assembly having a first transmitter, a switch, and a first power source, the assembly being mountable on a vehicle, wherein when the switch is activated, the first transmitter transmits a first signal;
a first box having a first receiver, a second transmitter, a third transmitter, a sensor, a microprocessor, and a second power source, the first box being mounted on the outside the vehicle, wherein the sensor detects reflections of pulses emitted by the second transmitter, wherein the microprocessor evaluates the reflections to determine the presence of a rigid object in the field of view that has a low clearance height for motor vehicle traffic, and wherein when the microprocessor detects the presence of the rigid object, the third transmitter transmits a second signal;
a second box, containing a second receiver, an output means, and a third power source, the second box being mountable in or on the vehicle, wherein when the second receiver receives the first signal from the assembly and the second signal from the first box, an output is created.

19. The protection system of claim 18 wherein the assembly is housed in a third box, the third box being removably attached to a roof rack and wherein the switch of the assembly is activated by the placement of an object in the roof rack.

20. The protection system of claim 18 wherein assembly is removably attached to a roof rack, the roof rack has a clamp to secure the object, and the switch is activated when the clamp is closed and securing the object.

21. A protection system comprising:
a first assembly having a transmitter and a first power source mounted on or near a rigid object; and
a second assembly having a receiver, an output means, and a second power source, the second assembly being mounted on a moveable object, wherein when the receiver receives a signal from the assembly, an output is created.

22. The protection system of claim 21 wherein the movable object is a vehicle and the rigid object presents a hazard to the vehicle.

23. The protection system of claim 21 wherein the rigid object has a low clearance height for motor vehicle traffic.

24. A protection system comprising:
an assembly containing a transmitter, a sensor, a microprocessor, a power source, and an output means, the assembly being mounted on or near a rigid object that presents a hazard for motor vehicle traffic,
wherein the sensor detects reflections of pulses emitted by the transmitter,
wherein the microprocessor evaluates the reflections to determine the presence of a movable object that is approaching the rigid object, and
wherein an output is created.

25. The protection system of claim 24 wherein the hazard is a low clearance height and wherein the microprocessor evaluates the reflections to determine if the approaching moveable object is taller than a clearance height of the hazard and creates an output when the approaching moveable object is taller than the clearance height of the hazard.
